(19) United States
(12) Patent Application Publication
(10) Pub. No.: US 2022/0122362 A1
(43) Pub. Date: Apr. 21, 2022

(54) IMAGE PROCESSING METHOD, APPARATUS AND DEVICE, AND STORAGE MEDIUM

(71) Applicant: SENSETIME INTERNATIONAL PTE. LTD., Singapore (SG)

(72) Inventors: Wenbin ZHANG, Singapore (SG); Yao ZHANG, Singapore (SG); Shuai ZHANG, Singapore (SG); Shuai YI, Singapore (SG)

(21) Appl. No.: 17/562,212

(22) Filed: Dec. 27, 2021

Related U.S. Application Data
(63) Continuation of application No. PCT/IB2021/062071, filed on Dec. 21, 2021.

(30) Foreign Application Priority Data
Dec. 17, 2021 (SG) 10202114028X

(51) Int. Cl. G06V 20/52; G06V 10/74

(52) U.S. Cl. CPC G06V 20/52; G06V 10/74

(57) ABSTRACT

Provided are an image processing method, apparatus and device, and a storage medium. The method includes following operations: from multiple images of a preset scene, total information of picture content in each of the multiple images is acquired; among the multiple images, at least two first images in which a change in picture content meets a preset condition are determined based on the total information of the picture content in the multiple images; incremental information of an object that changes is determined in the at least two first images; and the incremental information is fed to an upper-layer service to enable the upper-layer service to conduct a service related to the object based on the incremental information.

### CROSS-REFERENCE TO RELATED APPLICATIONS

This is a continuation application of International Application No. PCT/IB2021/062071, filed on Dec. 21, 2021, which claims priority to Singapore Patent Application No. 10202114028X, filed to the Singapore Patent Office on Dec. 17, 2021 and entitled “IMAGE PROCESSING METHOD, APPARATUS AND DEVICE, AND STORAGE MEDIUM”. The contents of International Application No. PCT/IB2021/062071 and Singapore Patent Application No. 10202114028X are incorporated herein by reference in their entireties.

### BACKGROUND

In an intelligent analysis system for a game place, the data required by an upper layer is generally given as total information frame by frame by a bottom layer. An upper-layer service performs related logic processing, filtering and further service logic judgment based on the total information. This brings more complexity to the service layer out of the service itself, rendering that the service layer cannot just focus on the service itself.

### SUMMARY

Embodiments of the disclosure relate to the technical field of image processing, and relate, but are not limited, to a data processing method and apparatus, a computer storage medium, a computer device and a computer program product.

The embodiments of the disclosure provide an image processing method, which may include: acquiring, from multiple images of a preset scene, total information of picture content in each of the multiple images; determining, among the multiple images based on the total information of the picture content in the multiple images, at least two first images in which a change in the picture content meets a preset condition; determining, in the at least two first images, incremental information of an object that changes; and feeding the incremental information to an upper-layer service to enable the upper-layer service to conduct a service related to the object based on the incremental information.

The embodiments of the application provide an image processing apparatus, which may include a first acquisition module, a first determination module, a second determination module and a first feeding module. The first acquisition module is configured to acquire, from multiple images of a preset scene, total information of picture content in each of the multiple images. The first determination module is configured to determine, among the multiple images based on the total information of the picture content in the multiple images, at least two first images in which a change in the picture content meets a preset condition. The second determination module is configured to determine, in the at least two first images, incremental information of an object that changes. The first feeding module is configured to feed the incremental information to an upper-layer service to enable the upper-layer service to conduct a service related to the object based on the incremental information.

The embodiments of the disclosure provide a non-transitory computer storage medium having stored thereon computer-executable instructions that, when executed, implement following actions: acquiring, from multiple images of a preset scene, total information of picture content in each of the multiple images; determining, among the multiple images based on the total information of the picture content in the multiple images, at least two first images in which a change in the picture content meets a preset condition; determining, in the at least two first images, incremental information of an object that changes; and feeding the incremental information to an upper-layer service to enable the upper-layer service to conduct a service related to the object based on the incremental information.

The embodiments of the disclosure provide a computer device, which may include a memory having stored thereon computer-executable instructions and a processor. The computer-executable instructions, when executed by the processor, cause the processor to implement following actions: acquiring, from multiple images of a preset scene, total information of picture content in each of the multiple images; determining, among the multiple images based on the total information of the picture content in the multiple images, at least two first images in which a change in the picture content meets a preset condition; determining, in the at least two first images, incremental information of an object that changes; and feeding the incremental information to an upper-layer service to enable the upper-layer service to conduct a service related to the object based on the incremental information.

The embodiments of the disclosure provide a computer program product, comprising computer-executable instructions that, when executed, implement the above image processing method, or implement a method for training an image processing network corresponding to the above image processing method.

### BRIEF DESCRIPTION OF THE DRAWINGS

The drawings herein are incorporated into and constitute a part of the specification, which illustrate embodiments in accordance with the application and together with the specification are used to explain the principle of the application.

FIG. 1 illustrates an implementation flowchart of an image processing method according to embodiments of the disclosure.

FIG. 2 illustrates another implementation flowchart of an image processing method according to embodiments of the disclosure.

FIG. 3 illustrates another implementation flowchart of an image processing method according to embodiments of the disclosure.

FIG. 4 illustrates a structural diagram of composition of an image processing apparatus according to embodiments of the disclosure.

FIG. 5 illustrates a structural diagram of composition of a computer device according to embodiments of the disclosure.

### DETAILED DESCRIPTION

To make the objectives, technical solutions, and advantages of the disclosure clearer, the specific technical solutions of the disclosure are described below in detail with reference to the accompanying drawings in the embodiments of the disclosure. The following embodiments are used for illustrating the disclosure rather than limiting the scope of the disclosure.

“Some embodiments” involved in the following descriptions describes a subset of all possible embodiments. However, it can be understood that “some embodiments” may be the same subset or different subsets of all the possible embodiments, and may be combined without conflicts.

Terms “first/second/third” involved in the following descriptions are only for distinguishing similar objects and do not represent a specific sequence of the objects. It can be understood that “first/second/third” may be interchanged to specific sequences or orders if allowed to implement the embodiments of the disclosure described herein in sequences except the illustrated or described ones.

Unless otherwise defined, all technological and scientific terms used in the disclosure have meanings the same as those usually understood by those skilled in the art of the application. The terms used in the disclosure only serve to describe the embodiments of the disclosure and not intended to limit the disclosure.

Before the embodiments of the disclosure are further described in detail, nouns and terms involved in the embodiments of the disclosure will be described. The nouns and terms involved in the embodiments of the disclosure are applicable to the following explanations.

(1) Blocking call, which means that before a call result returns, the present thread will be suspended, waiting for a message notification all the time, and other services cannot be executed. A function cannot return until obtaining the result.

(2) Callback function: when a program is running, some library function may require an application to pass it a function first, so that the function can be called at the right time to complete a target task. This function that is passed in and then called is referred to as the callback function.

The following descriptions are made to exemplary applications of an image processing device provided in the embodiments of the disclosure. The device provided in the embodiments of the disclosure may be implemented as various types of user terminals having an image acquisition function, such as a notebook, a tablet, a desktop computer, a camera and a mobile device (for example, a personal data assistant, a special messaging device and a portable game device), or may be implemented as a server. The descriptions are made below to an exemplary application in which the device is implemented as a terminal or a server.

The method may be applied to a computer device. Functions implemented by the method may be implemented by enabling a processor in the computer device to call program code. Of course, the program code may be stored in a computer storage medium. Hence, the computer device at least includes the processor and the storage medium.

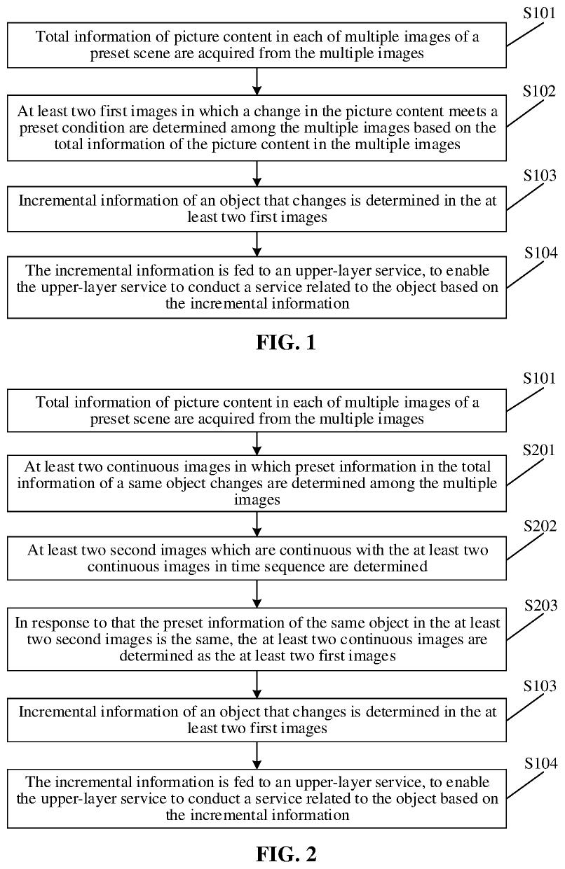

Some embodiments of the disclosure provide an image processing method, which is as illustrated in FIG. 1, and is described below in combination with actions S101-S104 illustrated in FIG. 1.

At S101, from multiple images of a preset scene, total information of picture content in each of the multiple images is acquired.

In some embodiments, the preset scene may be any scene, such as a game scene, a campus scene, a shopping mall scene or a restaurant scene, etc. The multiple images of the preset scene may be continuously acquired at different perspectives in the preset scene. The total information of the picture content in each of the multiple images includes information of all objects and background in the image and at least includes: a channel number of the image, the frame number of the image, a tracking identifier of each object in the image, position information of each object in the image, and a recognition result of each object in the image.

In a particular example, the preset scene is a game scene containing a game table. The multiple images may be acquired at any perspective in the game scene, and the objects contained in the images at least include: the game table, a player, game currency, a game currency exchange note and other game props. The total information of picture content in each image includes: the image channel of the image; the frame number of the image; and tracking identifiers, position information, recognition results, etc. of the game table, the player, the game currency, the game currency exchange note and other game props in the image. The recognition result of an object includes: the type, description information and posture of the object. With the object being game currency as an example, the recognition result of the game currency includes: the nominal value, the type, a number count, posture, etc. of the game currency.

At S102, at least two first images in which a change in the picture content meets a preset condition are determined among the multiple images based on the total information of the picture content in the multiple images.

In some embodiments, after an image of the preset scene is obtained, firstly, the total information of the image is determined and stored in a preset cache. Then, it is continued to acquire a second image, and store the total information of the second image in the preset cache. Until the total information corresponding to a certain number of images has been stored in the cache, whether the total information of a same object changes in these images is determined through comparison. If the total information of the same object changes in continuous images, and does not change in subsequent continuous images, these continuous images in which the total information of the same object changes are determined as the at least two first images that meet the preset condition.

In some possible implementations, with the preset scene being a game scene as an example, the objects in the image include a game table, game currency and other game props. If the total information of the game table, the game currency and other game props changes in some continuous images, and the total information of these objects does not change in subsequent continuous images, these continuous images in which the total information of the objects changes are regarded as the first images.

At S103, incremental information of an object that changes is determined in the at least two first images.

In some embodiments, the total information of each object is acquired from each first image; and by comparing the total information of a same object in the at least two first images, the object whose total information changes is determined. The change information of the object in the first images is taken as the incremental information of the object.

In a particular example, with the preset scene being a game scene and the object being game currency as an example, if the position information and the recognition result of the game currency changes in multiple first images, all change information of the game currency in the multiple first images is taken as the incremental information.

At S104, the incremental information is fed to an upper-layer service, to enable the upper-layer service to conduct a service related to the object based on the incremental information.

In some embodiments, after the incremental information is generated, the generated incremental information is uploaded to the upper-layer service. Based on a service requirement, the upper-layer service screens out the incremental information of the object that meets the service requirement from the uploaded incremental information according to the tracking identifier of each object, so as to conduct the service related to the object based on the incremental information of the object to satisfy the service requirement.

In some embodiments of the disclosure, the total information of picture content in each of multiple images of the preset scene is acquired from the multiple images. Firstly, among the multiple images, at least two first images in which a change in the picture content meets the preset condition are determined based on the total information; in this way, multiple first images that meet the preset condition can be screened out from the multiple images, and the number of images to be processed is reduced. Then, the incremental information of an object that changes is determined in the at least two first images. Finally, the incremental information is fed to the upper-layer service, so that the upper-layer service conducts a service related to the object based on the incremental information. In this way, a small amount of incremental information is uploaded to the upper-layer service, so that the data amount to be processed by the upper-layer service can be reduced, and thus the upper-layer service can focus on the service itself better, improving the service processing efficiency.

In some embodiments, when the acquired images are processed one by one, the total information of the objects in each image is determined. That is, the above operation S101 may be implemented by the following operations S111 to S114 (not shown in the drawings).

At S111, in response to obtaining one of the multiple images of the preset scene, total information of each object in the one of the images is determined.

In some embodiments, in the case that the system has obtained any image of the preset scene acquired by an image acquisition apparatus, the total information of each object in this image is determined by performing image detection and object recognition on this image. That is, the image channel of this image (for example, the serial number of the image acquisition apparatus corresponding to this image), the frame number of the image (that is, at which frame this image is arranged in time sequence), the tracking identifier of each object in this image, the position information of each object in this image, and the recognition results of each object in this image are determined.

At S112, a next image which is continuous with the one of the multiple images in time sequence is acquired.

In some embodiments, after the total information of the one of the multiple images is determined, firstly the total information of each object in the one of the images is stored in a preset cache, and then it is continued to acquire a next image which is continuous with this image in time sequence. Alternatively, after the total information of the one of the multiple images is determined, it is directly continued to acquire the next image which is continuous with this image in time sequence; and in the case that the total information corresponding to a preset number of images is acquired, the total information corresponding to the preset number of images is stored in the preset cache.

At S113, total information of each object in the next image is determined to obtain the total information of the picture content in each of the multiple images.

In some embodiments, image detection and object recognition are performed on the next image in the same manner as S111 to determine the total information of each object in the next image. That is, the image channel of this image, the frame number of this image, the tracking identifier of each object in this image, the position information of each object in this image and the recognition result of each object in the image are determined in the next image. In some possible implementations, in the case that the number of images of which the total information has been determined reaches a preset value, the determined total information is stored in the preset cache. Alternatively, each time the total information of an image is determined, the total information is stored in the preset cache, until the number of images corresponding to the total information stored in the preset cache reaches the preset value. The images the number of which is the preset value are compared to determine whether there are first images meeting the preset condition.

In some embodiments, through the above-operations S111 to S113, image detection and recognition are performed on the acquired images one by one, so as to obtain the total information of each object in each image, and further obtain the total information of the picture content in each of the multiple images. In this way, by processing the acquired images one by one to determine the total information corresponding to each image, the processing efficiency in determining the total information of the images can be improved.

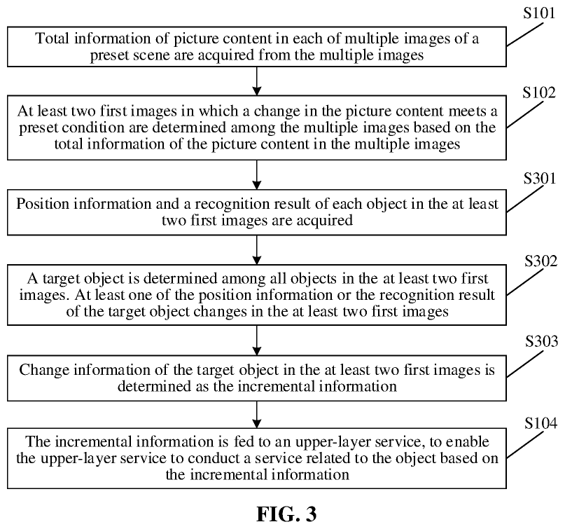

In some embodiments, the first images are screened out from the multiple images by determining that the total information of an object changes in former ones of the multiple images and remains stable in subsequent ones of the multiple images. That is, the above operation S102 may be implemented by the operations illustrated in FIG. 2. FIG. 2 illustrates another implementation flowchart of an image processing method according to embodiments of the disclosure, which is described below in combination with the operations illustrated in FIG. 1 and FIG. 2.

At S201, at least two continuous images in which preset information in the total information of a same object changes are determined among the multiple images.

In some embodiments, the preset information in the total information is partial information in the total information. For example, the total information includes: a channel number of the image to which the total information belongs, the frame number of the image, the tracking identifier of each object in the image, position information of each object in the image, and a recognition result of each object in the image. The preset information is the position information and the recognition result of an object in the total information.

In some possible implementations, the acquired images are processed one by one. That is, after an image is acquired, the total information corresponding to this image is determined, and the total information of each object in this image is stored in the preset cache; this is continued until the number of images corresponding to the total information stored in the preset cache meets the preset number. Whether the total information of the same object changes or not is determined by comparison based on the total information of the objects in these images. That is, the number of images corresponding to the total information stored in the preset cache is firstly determined. Then, in response to the number of images meeting the preset number, at least two continuous images in which the preset information in the total information of a same object changes are determined among the images meeting the preset number. In this way, in the case that the number of images of which the total information is determined one by one meets the preset number, operation S201 is executed, so that the comparison of the total information can be implemented in a timely manner and the image processing efficiency can be improved. For example, after the total information of five continuous images is determined, S201 is executed, so as to determine, through comparison, whether the position information and recognition result of the same object change in the five continuous images or not. If the preset information is the position information and recognition result of the object in the total information, the at least two continuous images in which at least one of the position information and the recognition result of the same object changes are determined among the multiple images. In a particular example, with the preset scene being a game scene and the same object being game currency as an example, if the position information of the game currency in the images and the recognition result of the game currency change in three continuous images among the multiple images, the three continuous images are determined. In this way, by comparing whether the position information and the recognition result of the same object in several continuous images change or not, continuous images in which the position information and the recognition results of the same object change are screened out from the multiple images, so that the data amount subsequently uploaded to the upper-layer service can be reduced. In this way, continuous images in which a change occurs are screened out from multiple images, so that the data amount subsequently uploaded to the upper-layer service can be reduced.

At S202, at least two second images which are continuous with the at least two continuous images in time sequence are determined.

In some embodiments, the next images, namely the second images, which are continuous with the continuous images in time sequence are determined among the multiple images. For example, if the position information and/or recognition result of the same object changes in five continuous images, multiple continuous second images (for example, three continuous second images) after the five continuous images are determined.

At S203, in response to that the preset information of the same object in the at least two second images is the same, the at least two continuous images are determined as the at least two first images.

In some embodiments, if the position information and recognition result of the same object remain stable in at least two second images, that is, the position information and recognition result of the same object are the same in the second images, the at least two continuous images are determined as the at least two first images. For example, if the position information and recognition result of the object are the same in three continuous images after the five continuous images, the five continuous images are determined as the first images.

In the embodiments of the disclosure, by processing acquired images one by one and storing total information corresponding to the images in the preset cache, and determining whether the position information and/or recognition result of the same object changes by comparison based on the total information corresponding to continuous images stored in the cache, first images in which preset information of the object changes can be screened out in a timely manner accurately. Incremental information can be produced while generating total information.

In some embodiments, the position information and recognition result of the same object in the multiple images are compared to determine a target object that changes, so that the incremental information of the target object is determined. That is, the above-mentioned operation S103 may be implemented by the operations illustrated in FIG. 3. FIG. 3 illustrates yet another implementation flowchart of an image processing method according to embodiments of the disclosure, which is described below in combination with the actions illustrated in FIG. 3.

At S301, position information and a recognition result of each object in the at least two first images are acquired.

In some embodiments, the number of the at least two first images meets the preset number, and the total information of the at least two first images is stored in the preset cache. The position information and the recognition result of each object in each first image are acquired from the preset cache.

At S302, a target object is determined among all objects in the at least two first images. At least one of the position information or the recognition result of the target object changes in the at least two first images.

In some embodiments, an object of which at least one of the position information or the recognition result changes is determined as the target object based on the position information and the recognition results of all objects. With the preset scene being a game scene as an example, if the position of the game currency changes in the three continuous first images, the game currency is determined as the target object. Alternatively, if the recognition result of the game currency (for example, the nominal value, the number count, type or posture of the game currency) changes in the three continuous first images change, the game currency is determined as the target object. Alternatively, if both the position and recognition result of the game currency changes in the three continuous first images, the game currency is determined as the target object.

At S303, change information of the target object in the at least two first images is determined as the incremental information.

In some embodiments, all the target objects whose position information and/or recognition results change in the first images are determined, and at least part of the change information of these target objects in the first images is taken as the incremental information. For example, all the change information of these target objects in the first images is taken as the incremental information.

In the embodiments of the disclosure, the target object whose position information and recognition result change is analyzed in the first images, and all change information of the target object in the first images is taken as the incremental information, so that the richness of the acquired incremental information can be improved, without increasing the workload of service processing of the upper-layer service.

In some embodiments, when an image processing system is initialized, an incremental information distribution thread is created, so that the incremental information can be distributed by means of the asynchronous independent thread. That is, in the initialization stage of the system, a thread for distributing the incremental information is created in response to a received initialization instruction. In this way, after the thread is created, the incremental information, when generated, can be distributed by means of the asynchronous independent thread. That is, the above operation S104 may be implemented by operation S141.

At S141, the incremental information is fed to the upper-layer service based on the thread.

In this way, after the incremental information is generated, the thread may be used to immediately process the incremental information and upload the incremental information to the upper-layer service, without affecting the logical process of processing images one by one to determine the total information.

In some embodiments, the upper-layer service may acquire the incremental information in the following two modes.

Mode 1: in a blocking manner, the upper-layer service waits for a notification from the thread that the incremental information is generated. After receiving the notification, the upper-layer service acquires the incremental information from a designated memory position, and performs parsing with a specific data structure so as to obtain the incremental information. This may be implemented by the following operations.

Firstly, the incremental information is stored in a storage with a preset address, and the notification information is fed to the thread.

In some embodiments, the storage with the preset address may be a storage address set by negotiation with the upper-layer service, so that the upper-layer service can obtain the incremental information from the storage according to the preset address. The notification information is for informing that the incremental information has been generated in the thread.

Secondly, in response to detecting the notification information, the notification information is uploaded to the upper-layer service, to enable the upper-layer service to acquire the incremental information from the storage with the preset address.

In some embodiments, the notification information is uploaded to the upper-layer service to inform the upper-layer service that the incremental information has been generated in the thread, and to prompt the upper-layer service to acquire the incremental information from the storage according to the preset address. The acquired incremental information is parsed through a specific data structure, for processing the services related to the incremental information. In this way, after detecting the notification information, the upper-layer service actively acquires the incremental information from the storage according to the preset address, so that the upper-layer service can acquire the service-related incremental information in a more timely manner, thereby improving the service processing speed of the upper-layer service.

Mode 2: when the system is initialized, a callback function for processing the incremental information is passed in. When the incremental information is generated, the thread immediately calls the callback function actively. This may be implemented by the following operations.

Firstly, the incremental information is stored in the storage with the preset address, and the notification information is fed to the thread. In this way, the thread can learn the generation of the incremental information in a timely manner, so as to feed it to the upper-layer service in a timely manner

Secondly, a callback function for processing the incremental information is created based on the service requirement of the upper-layer service.

In some embodiments, the callback function may be created in the same stage as the incremental information distribution thread. That is, the callback function is created in the system initialization stage. That is, in response to the initialization instruction of the system, a processing logic of the callback function matched with the service requirement of the upper-layer service is created based on the service requirement. In this way, the created callback function can process the called incremental information based on the processing logic, to realize the service requirement.

Thirdly, in response to the detected notification information, the thread is used to call the callback function, so that the upper-layer service can acquire the incremental information.

In some embodiments, after the incremental information is generated, the notification information is sent to the thread. When receiving the notification information, the thread actively calls the callback function to call the generated incremental information, so that the upper-layer service can obtain the incremental information.

In the embodiments of the disclosure, the processing logic of the callback function is created based on the customized service requirement of the upper-layer service, and after the incremental information is generated, the distribution thread actively calls the callback function, so that the callback function can process the incremental information based on the processing logic, thereby completing the service processing process of the upper-layer service. In this way, the incremental information can be immediately processed by the asynchronous incremental information distribution thread, which enables the upper-layer service to focus on service processing based on the service requirement without affecting the process of processing images one by one.

Hereinafter, an exemplary application of the embodiments of the disclosure in an actual application scenario will be described below. With the application scenario being a game place as an example, descriptions are made with an example of acquiring images for the game table by a camera in the game place.

The embodiments of the disclosure provide an image processing method. In a game table analysis system, in the process of processing images one by one to generate total information, the incremental information is generated by comparing total information of images one by one. The generated incremental information is stored in a designated memory. The service layer acquires the incremental information as required, or the callback function provided by the service layer is directly called to notify the service layer to acquire the incremental information. This may be implemented by the following operations.

Firstly, an incremental information distribution thread is created when the game table analysis system is initialized.

Secondly, the total information of an object is generated when camera photos of the game table are processed one by one.

In some embodiments, the total information of the object includes, but is not limited to, the channel number, frame number, tracking ID, position, and recognition result of the object (for example, the nominal value, type, the number count, and posture of the game currency, etc.). The total information is stored in the cache and compared with the total information of previous images. The comparison is made based on whether the position and the recognition result of the object change or not, and the picture content is stable in continuous images after the images in which the change occurs. If there is a change in the acquired images and continuous images after the images in which there is the change occurs are stable and contain no occlusion, the total information of the object that changes is taken as the generated incremental information. The incremental information includes which person does what to which object in which image, is stored in a specific memory position with a preset data structure, and is informed to the incremental information distribution thread.

Thirdly, the incremental information distribution thread processes the incremental information in two modes.

Mode 1: in a blocking manner, the upper-layer service waits for a notification of generated incremental information from a main thread. After receiving the notification, the upper-layer service acquires the incremental information from the designated memory position, and parses the acquired incremental information with a specific data structure.

Mode 2: in initialization of the game table analysis system, a callback function for processing the incremental information is passed in. When the incremental information is generated, the incremental information distribution thread immediately calls the callback function actively. Herein, the processing logic of the callback function is customized by the upper-layer service.

Fourthly, after acquiring the incremental information, the upper-layer service performs service logic processing based on the incremental information.

In the embodiments of the disclosure, the incremental information is also generated while the total information is generated, and the incremental information is distributed by means of the asynchronous independent thread. In this way, the incremental information enables the upper-layer service to better focus on service logic processing. Moreover, the asynchronous incremental information distribution thread can immediately process the incremental information without affecting the logic of processing images one by one.

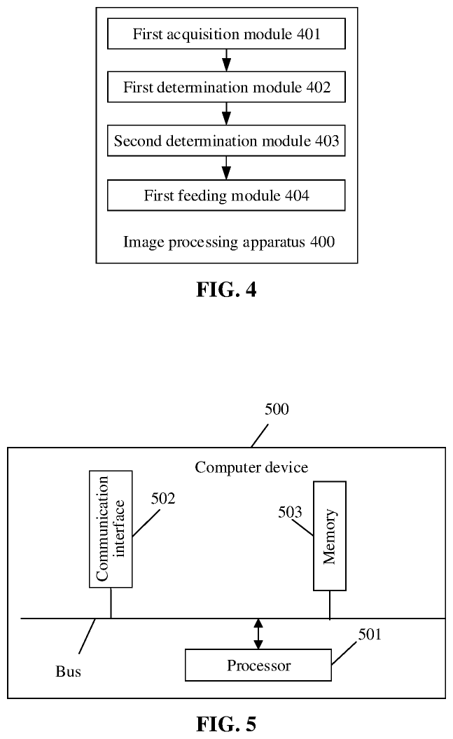

The embodiments of the disclosure provide an image processing apparatus. FIG. 4 illustrates a structural diagram of composition of the image processing apparatus according to embodiments of the disclosure. As illustrated in FIG. 4, the image processing apparatus 400 includes a first acquisition module 401, a first determination module 402, a second determination module 403, and a first feeding module 404.

The first acquisition module 401 is configured to acquire, from multiple images of a preset scene, total information of picture content in each of the multiple images.

The first determination module 402 is configured to determine, among the multiple images based on the total information of the picture content in the multiple images, at least two first images in which a change in the picture content meets a preset condition.

The second determination module 403 is configured to determine, in the at least two first images, incremental information of an object that changes.

The first feeding module 404 is configured to feed the incremental information to an upper-layer service to enable the upper-layer service to conduct a service related to the object based on the incremental information.

In some embodiments, the first acquisition module 401 includes a first determination sub-module, a first acquisition sub-module, and a second determination sub-module.

The first determination sub-module is configured to: in response to obtaining one of the multiple images of the preset scene, determine total information of each object in the one of the multiple images.

The first acquisition sub-module is configured to acquire a next image which is continuous with the one of the multiple images in time sequence.

The second determination sub-module is configured to determine total information of each object in the next image to obtain the total information of the picture content in each of the multiple images.

In some embodiments, the first determination module 402 includes a third determination sub-module, a fourth determination sub-module, and a fifth determination sub-module.

The third determination sub-module is configured to determine, among the multiple images, at least two continuous images in which preset information in the total information of a same object changes.

The fourth determination sub-module is configured to determine at least two second images which are continuous with the at least two continuous images in time sequence.

The fifth determination sub-module is configured to: in response to that the preset information of the same object in the at least two second images is the same, determine the at least two continuous images as the at least two first images.

In some embodiments, the apparatus further includes a first storage module.

The first storage module is configured to store, in a preset cache, the total information of each object in the one of the multiple images.

The third determination sub-module is further configured to: store a number of images corresponding to all total information stored in the preset cache; and in response to the number of images meeting a preset number, determine, among the number of images meeting the preset number, the at least two continuous images in which the preset information in the total information of the same object changes.

In some embodiments, the total information of the picture content in each of the multiple images includes at least one of: a channel number of the image, a frame number of the image, a tracking identifier of each object in the image, position information of each object in the image, or a recognition result of each object in the image.

The third determination sub-module includes a first determination unit.

The first determination unit is configured to determine, among the number of images meeting the preset number, the at least two continuous images in which at least one of the position information or the recognition result of the same object changes.

In some embodiments, the second determination module 403 includes a second acquisition sub-module, a sixth determination sub-module and a seventh determination sub-module.

The second acquisition sub-module is configured to acquire position information and a recognition result of each object in the at least two first images.

The sixth determination sub-module is configured to determine a target object among all objects in the at least two first images. At least one of the position information or the recognition result of the target object changes in the at least two first images.

The seventh determination sub-module is configured to take change information of the target object in the at least two first images as the incremental information.

In some embodiments, the apparatus further includes: a creation module, configured to: in response to receiving an initialization instruction, create a thread for distributing the incremental information.

The first feeding module 404 includes a first feeding sub-module.

The first feeding sub-module is configured to feed the incremental information to the upper-layer service based on the thread.

In some embodiments, the first feeding sub-module includes a first uploading unit.

The first uploading unit is configured to: in response to detecting notification information, upload the notification information to the upper-layer service, to enable the upper-layer service to acquire the incremental information from a storage with a preset address. The notification information is used for informing that the incremental information has been generated in the thread.

In some embodiments, the apparatus further includes a first storage module.

The first storage module is configured to store the incremental information in the storage with the preset address, and feed the notification information to the thread.

In some embodiments, the first feeding sub-module includes a first creation unit, and a first calling unit.

The first creation unit is configured to create, based on a service requirement of the upper-layer service, a callback function for processing the incremental information.

The first calling unit is configured to: in response to detecting the notification information, use the thread to call the callback function, to enable the upper-layer service to acquire the incremental information.

It is to be noted that descriptions about the above apparatus embodiment are similar to descriptions about the method embodiment and beneficial effects similar to those of the method embodiment are achieved. Technical details undisclosed in the apparatus embodiment of the disclosure may be understood with reference to the descriptions about the method embodiment of the disclosure.

It is to be noted that, in the embodiments of the disclosure, when implemented in form of software function module and sold or used as an independent product, the image processing method may also be stored in a computer-readable storage medium. Based on such an understanding, the technical solutions of the embodiments of the disclosure substantially or parts making contributions to the conventional art may be embodied in form of software product, and the computer software product is stored in a storage medium, including instructions configured to enable a computer device (which may be a terminal, a server, etc.) to execute all or part of the method in each embodiment of the disclosure. The storage medium includes various media capable of storing program codes such as a USB flash disk, a mobile hard disk, a Read Only Memory (ROM), a magnetic disk or an optical disk. Therefore, the embodiments of the disclosure are not limited to any specific hardware and software combination.

The embodiments of the disclosure also provide a computer program product, which includes computer-executable instructions. The computer-executable instruction is executed to implement the image processing method provided in the embodiments of the disclosure, or a method for training an image processing network corresponding to the above image processing method.

The embodiments of the application also provide a computer storage medium, in which computer-executable instructions are stored. When executed by a processor, the computer-executable instructions cause the processor to implement the image processing method provided in the above embodiment, or a method for training an image processing network corresponding to the above image processing method.

The embodiments of the present disclosure provide a computer device. FIG. 5 illustrates a structural diagram of composition of a computer device according to embodiments of the disclosure. As illustrated in FIG. 5, the computer device 500 include: a processor 501, at least one communication bus, a communication interface 502, at least one external communication interface and a memory 503. The communication bus 502 is configured to implement connection and communication among these components. The communication bus 502 may include a display screen, and the external communication interface may include a standard wired interface and a wireless interface. The processor 501 is configured to execute an image processing program in the memory to implement the image processing method provided in the above embodiment.

The descriptions about the embodiments of the image processing apparatus, the computer device and the storage medium are similar to those of the above method embodiment, so the technical descriptions and beneficial effects are the same to the corresponding method embodiment, which may refer to the disclosures of the method embodiment for simplicity and will not be repeated herein. A technical detail undisclosed in the embodiments of the image processing apparatus, computer device and storage medium of the disclosure may be understood with reference to the descriptions on the method embodiment of the disclosure.

The embodiments of the disclosure provide an image processing method, apparatus and device, and a storage medium. The total information of picture content in each of multiple images of the preset scene is acquired from the multiple images. Firstly, among the multiple images, at least two first images in which a change in the picture content meets the preset condition are determined based on the total information; in this way, multiple first images that meet the preset condition can be screened out from the multiple images, and the number of images to be processed is reduced. Then, the incremental information of an object that changes is determined in the at least two first images. Finally, the incremental information is fed to the upper-layer service, so that the upper-layer service conducts a service related to the object based on the incremental information. In this way, a small amount of incremental information is uploaded to the upper-layer service, so that the data amount to be processed by the upper-layer service can be reduced, and thus the upper-layer service can focus on the service itself better, improving the service processing efficiency.

It is to be understood that reference throughout this specification to “one embodiment” or “an embodiment” means that particular features, structures, or characteristics described in connection with the embodiment is included in at least one embodiment of the disclosure. Thus, the appearances of the phrases “in one embodiment” or “in an embodiment” in various places throughout this specification are not necessarily all referring to the same embodiment. Furthermore, these particular features, structures, or characteristics may be combined in any suitable manner in one or more embodiments. It is further to be understood that the sequence numbers of the foregoing processes do not mean execution sequences in various embodiments of the disclosure. The execution sequences of the processes should be determined according to functions and internal logics of the processes, and should not be construed as any limitation to the implementation processes of the embodiments of the disclosure. The serial numbers of the embodiments of the disclosure are merely for description and do not represent a preference of the embodiments. It is to be noted that the terms “include”, “contain” or any other variations thereof are intended to cover a non-exclusive inclusion, such that a process, method, article or apparatus including a series of elements not only includes those elements, but also includes those elements that are not explicitly listed, or includes elements inherent to such a process, method, article or apparatus. Under the condition of no more limitations, it is not excluded that additional identical elements further exist in the process, method, article or apparatus including an element defined by a sentence “including a . . . ”.

In the several embodiments provided in the disclosure, it should be understood that the disclosed device and method may be implemented in other manners. The device embodiment described above is only illustrative, and for example, division of the units is only logic function division, and other division manners may be adopted during practical implementation. For example, multiple units or components may be combined or integrated into another system, or some characteristics may be neglected or not executed. In addition, coupling or direct coupling or communication connection between displayed or discussed components may be indirect coupling or communication connection implemented through some interfaces, devices, or units, and may be electrical and mechanical or in other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, function units in embodiments of the disclosure may be integrated into a processing unit, or may exist independently, and two or more than two units may also be integrated into one unit. The integrated unit may be implemented in a hardware form, or may be implemented in form of hardware and software function unit. Those of ordinary skill in the art should understand that: all or some of the operations of the abovementioned method embodiment may be implemented by instructing related hardware through a program, the abovementioned program may be stored in a computer-readable storage medium, and the program is executed to execute the operations of the abovementioned method embodiment. The storage medium includes: various media capable of storing program codes such as a mobile storage device, an ROM, a magnetic disk or an optical disc.

Alternatively, when being implemented in form of software function module and sold or used as an independent product, the integrated unit of the present application may also be stored in a computer-readable storage medium. Based on such an understanding, the technical solutions of the embodiments of the disclosure substantially or parts making contributions to the conventional art may be embodied in form of software product, and the computer software product is stored in a storage medium, including instructions configured to enable a computer device (which may be a personal computer, a server, network equipment or the like) to execute all or part of the method in each embodiment of the disclosure. The abovementioned storage medium includes various media capable of storing program codes such as a mobile storage device, a ROM, a magnetic disk or an optical disc. The above is only the specific implementation of the disclosure and not intended to limit the scope of protection of the disclosure. Any variations or replacements apparent to those skilled in the art within the technical scope disclosed by the disclosure shall fall within the scope of protection of the disclosure. Therefore, the scope of protection of the disclosure shall be subjected to the scope of protection of the claims.

1. An image processing method, performed by a computer device, comprising:
acquiring, from multiple images of a preset scene, total information of picture content in each of the multiple images;
determining, among the multiple images based on the total information of the picture content in the multiple images, at least two first images in which a change in the picture content meets a preset condition;
determining, in the at least two first images, incremental information of an object that changes; and
feeding the incremental information to an upper-layer service to enable the upper-layer service to conduct a service related to the object based on the incremental information.

2. The method of claim 1, wherein the acquiring, from multiple images of a preset scene, total information of picture content in each of the multiple images comprises:
in response to obtaining one of the multiple images of the preset scene, determining total information of each object in the one of the multiple images;
acquiring a next image which is continuous with the one of the multiple images in time sequence; and
determining total information of each object in the next image to obtain the total information of the picture content in each of the multiple images.

3. The method of claim 1, wherein the determining, among the multiple images based on the total information of the picture content in the multiple images, at least two first images in which a change in the picture content meets a preset condition comprises:
determining, among the multiple images, at least two continuous images in which preset information in the total information of a same object changes;
determining at least two second images which are continuous with the at least two continuous images in time sequence; and
in response to that the preset information of the same object in the at least two second images is the same, determining the at least two continuous images as the at least two first images.

4. The method of claim 2, before the acquiring a next image which is continuous with the one of the multiple images in time sequence, further comprising:
storing, in a preset cache, the total information of each object in the one of the multiple images;
wherein the determining, among the multiple images, at least two continuous images in which preset information in the total information of a same object changes comprises:
determining a number of images corresponding to all total information stored in the preset cache; and
in response to the number of images meeting a preset number, determining, among the number of images meeting the preset number, the at least two continuous images in which the preset information in the total information of the same object changes.

5. The method of claim 4, wherein the total information of the picture content in each of the multiple images comprises at least one of: a channel number of the image, a frame number of the image, a tracking identifier of each object in the image, position information of each object in the image, or a recognition result of each object in the image, and
wherein the in response to the number of images meeting a preset number, determining, among the number of images meeting the preset number, the at least two continuous images in which the preset information in the total information of the same object changes comprises:
determining, among the number of images meeting the preset number, the at least two continuous images in which at least one of the position information or the recognition result of the same object changes.

6. The method of claim 1, wherein the determining, in the at least two first images, incremental information of an object that changes comprises:
acquiring position information and a recognition result of each object in the at least two first images;
determining a target object among all objects in the at least two first images, wherein at least one of the position information or the recognition result of the target object changes in the at least two first images; and
taking change information of the target object in the at least two first images as the incremental information.

7. The method of claim 1, further comprising:
in response to receiving an initialization instruction, creating a thread for distributing the incremental information,
wherein the feeding the incremental information to an upper-layer service comprises:
feeding the incremental information to the upper-layer service based on the thread.

8. The method of claim 7, wherein the feeding the incremental information to the upper-layer service based on the thread comprises:
in response to detecting notification information, uploading the notification information to the upper-layer service, to enable the upper-layer service to acquire the incremental information from a storage with a preset address, wherein the notification information is used for informing that the incremental information has been generated in the thread.

9. The method of claim 8, after the determining incremental information of an object that changes in the at least two first images, further comprising:
storing the incremental information in the storage with the preset address, and feeding the notification information to the thread.

10. The method of claim 8, wherein the feeding the incremental information to the upper-layer service based on the thread comprises:
creating, based on a service requirement of the upper-layer service, a callback function for processing the incremental information; and
in response to detecting the notification information, using the thread to call the callback function, to enable the upper-layer service to acquire the incremental information.

11. A computer device, comprising:
a memory having stored thereon computer-executable instructions, and
a processor,
wherein the computer-executable instructions, when executed by the processor, cause the processor to:
acquire, from multiple images of a preset scene, total information of picture content in each of the multiple images;
determine, among the multiple images based on the total information of the picture content in the multiple images, at least two first images in which a change in the picture content meets a preset condition;
determine, in the at least two first images, incremental information of an object that changes; and
feed the incremental information to an upper-layer service to enable the upper-layer service to conduct a service related to the object based on the incremental information.

12. The computer device of claim 11, wherein in acquiring, from multiple images of a preset scene, total information of picture content in each of the multiple images, the processor is caused to:
in response to obtaining one of the multiple images of the preset scene, determine total information of each object in the one of the multiple images;
acquire a next image which is continuous with the one of the multiple images in time sequence; and
determine total information of each object in the next image to obtain the total information of the picture content in each of the multiple images.

13. The computer device of claim 11, wherein in determining, among the multiple images based on the total information of the picture content in the multiple images, at least two first images in which a change in the picture content meets a preset condition, the processor is caused to:
determine, among the multiple images, at least two continuous images in which preset information in the total information of a same object changes;
determine at least two second images which are continuous with the at least two continuous images in time sequence; and
in response to that the preset information of the same object in the at least two second images is the same, determine the at least two continuous images as the at least two first images.

14. The computer device of claim 12, before the acquiring a next image which is continuous with the one of the multiple images in time sequence, the processor is further caused to:
store, in a preset cache, the total information of each object in the one of the multiple images; and
store a number of images corresponding to all total information stored in the preset cache; and in response to the number of images meeting a preset number, determine, among the number of images meeting the preset number, at least two continuous images in which preset information in the total information of the same object changes.

15. The computer device of claim 14, wherein the total information of the picture content in each of the multiple images comprises at least one of: a channel number of the image, a frame number of the image, a tracking identifier of each object in the image, position information of each object in the image, or a recognition result of each object in the image, and
wherein in in response to the number of images meeting a preset number, determining, among the number of images meeting the preset number, the at least two continuous images in which the preset information in the total information of the same object changes, the processor is caused to:
determine, among the number of images meeting the preset number, the at least two continuous images in which at least one of the position information or the recognition result of the same object changes.

16. The computer device of claim 11, wherein in determining, in the at least two first images, incremental information of an object that changes, the processor is caused to:
acquire position information and a recognition result of each object in the at least two first images;
determine a target object among all objects in the at least two first images, wherein at least one of the position information or the recognition result of the target object changes in the at least two first images; and
take change information of the target object in the at least two first images as the incremental information.

17. The computer device of claim 11, the processor is further caused to:
in response to receiving an initialization instruction, create a thread for distributing the incremental information,
wherein in feeding the incremental information to an upper-layer service, the processor is caused to:
feed the incremental information to the upper-layer service based on the thread.

18. The computer device of claim 17, wherein in feeding the incremental information to the upper-layer service based on the thread, the processor is caused to:
in response to detecting notification information, upload the notification information to the upper-layer service, to enable the upper-layer service to acquire the incremental information from a storage with a preset address, wherein the notification information is used for informing that the incremental information has been generated in the thread.

19. The computer device of claim 18, after the determining incremental information of an object that changes in the at least two first images, the processor is further caused to:
store the incremental information in the storage with the preset address, and feed the notification information to the thread.

20. A non-transitory computer storage medium having stored thereon computer executable instructions that, when executed, implement following:
acquiring, from multiple images of a preset scene, total information of picture content in each of the multiple images;
determining, among the multiple images based on the total information of the picture content in the multiple images, at least two first images in which a change in the picture content meets a preset condition;
determining, in the at least two first images, incremental information of an object that changes; and
feeding the incremental information to an upper-layer service to enable the upper-layer service to conduct a service related to the object based on the incremental information.
